(19) United States
(12) Patent Application Publication
(10) Pub. No.: US 2024/0136781 A1
(43) Pub. Date: Apr. 25, 2024

(54) SYSTEMS AND METHODS FOR COAXIAL BOARD TO BOARD CONNECTIONS

(71) Applicant: Smiths Interconnect Americas, Inc., Kansas City, KS (US)

(72) Inventors: Mathew Kurien, Kansas City, KS (US); Augustus H. Brown, Overland Park, KS (US); Trevor Mitchell, Mission, KS (US); David M. Post, Jr., Lee Summit, MO (US)

(21) Appl. No.: 18/278,539

(22) PCT Filed: Feb. 21, 2022
(86) PCT No.: PCT/US2022/017155

§ 371 Date: Aug. 22, 2023

Related U.S. Application Data
(60) Provisional application No. 63/153,217, filed on Feb. 24, 2021.

(51) Int. Cl. H01R 24/54; H01R 13/24; H01R 31/06

(52) U.S. Cl. CPC H01R 24/54; H01R 13/2407; H01R 31/06

(57) ABSTRACT

An RF connector is provided. The RF connector includes a first outer contactor, an outer sleeve in contact with the first outer contactor, an outer spring in contact with the first outer contactor and configured to resist axial translation of the first outer contactor with respect to the outer sleeve, a first inner contactor, an inner sleeve in contact with the first inner contactor, and an inner spring in contact with the first inner contactor and configured to resist axial translation of the first inner contactor with respect to the inner sleeve. The RF connector is configured to be removably coupled between a first board and a second board when axially compressed between the first and second boards, and a resistance to the axial compression provided by the outer spring and the inner spring holds the RF connector in place with respect to the first and second boards.

### CROSS-REFERENCE TO RELATED APPLICATIONS

This application claims the benefit of, and priority to, U.S. Provisional Patent Application Ser. No. 63/153,217, filed Feb. 24, 2021, and entitled “SYSTEMS AND METHODS FOR COAXIAL BOARD TO BOARD CONNECTIONS,” the contents of which are incorporated herein in their entirety.

### BACKGROUND

The embodiments described herein relate generally to electrical interconnects, and more particularly, to coaxial radio frequency (RF) board to board interconnects.

In electronics systems, connectors are used to provide communicative connections between different components such as, for example, between circuit boards. Current connectors generally must be custom fit between boards or use wires to connect boards, which may be inefficient with respect to usage of space and material. Further, such connectors may not perform adequately over a wide band of communication signal frequencies. A coaxial connector that is capable of connecting boards or other components in a variety of different configurations while reducing usage of space and material and maintaining performance capability across a wide band of frequencies is therefore desirable.

### BRIEF SUMMARY

In one aspect, an RF connector is provided. The RF connector includes a first outer contactor including a first radially inner surface and defining an axis. The RF connector further includes an outer sleeve coaxial with the first outer contactor and in contact with the first outer contactor, wherein the first outer contactor is axially translatable with respect to the outer sleeve. The RF connector further includes an outer spring in contact with the first outer contactor and configured to resist axial translation of the first outer contactor with respect to the outer sleeve. The RF connector further includes a first inner contactor including a first radially outer surface and coaxial with the first outer contactor. The RF connector further includes an inner sleeve coaxial with the first outer contactor and in contact with the first inner contactor, wherein the first inner contactor is axially translatable with respect to the inner sleeve. The RF connector further includes an inner spring in contact with the first inner contactor and configured to resist axial translation of the first inner contactor with respect to the inner sleeve. The RF connector further includes a dielectric disposed radially between the outer sleeve and the inner sleeve. The RF connector is configured to be removably coupled between a first board and a second board when axially compressed between the first board and the second board, and a resistance to the axial compression provided by the outer spring and the inner spring holds the RF connector in place with respect to the first board and the second board.

In another aspect, a method of manufacturing an RF connector is provided. The method includes forming a first outer contactor having a first radially inner surface, the first outer contactor defining an axis. The method further includes positioning an outer sleeve coaxially with the first outer contactor and in contact with the first outer contactor, the first outer contactor axially translatable with respect to the outer sleeve. The method further includes positioning an outer spring in contact with the first outer contactor, the outer spring configured to resist axial translation of the first outer contactor with respect to the outer sleeve. The method further includes positioning a first inner contactor coaxially with the first outer contactor, the first inner contactor including a first radially outer surface. The method further includes positioning an inner sleeve coaxially with the first outer contactor and in contact with the first inner contactor, the first inner contactor axially translatable with respect to the inner sleeve. The method further includes positioning an inner spring in contact with the first inner contactor, the inner spring configured to resist axial translation of the first inner contactor with respect to the inner sleeve. The method further includes positioning a dielectric radially between the outer sleeve and the inner sleeve. The RF connector is configured to be removably coupled between a first board and a second board when axially compressed between the first board and the second board, and a resistance to the axial compression provided by the outer spring and the inner spring holds the RF connector in place with respect to the first board and the second board.

In another aspect an RF assembly is provided. The RR assembly includes a first board, a second board, and an RF connector. The RF connector includes a first outer contactor including a first radially inner surface and defining an axis. The RF connector further includes an outer sleeve coaxial with the first outer contactor and in contact with the first outer contactor, wherein the first outer contactor is axially translatable with respect to the outer sleeve. The RF connector further includes an outer spring in contact with the first outer contactor and configured to resist axial translation of the first outer contactor with respect to the outer sleeve. The RF connector further includes a first inner contactor including a first radially outer surface and coaxial with the first outer contactor. The RF connector further includes an inner sleeve coaxial with the first outer contactor and in contact with the first inner contactor, wherein the first inner contactor is axially translatable with respect to the inner sleeve. The RF connector further includes an inner spring in contact with the first inner contactor and configured to resist axial translation of the first inner contactor with respect to the inner sleeve. The RF connector further includes a dielectric disposed radially between the outer sleeve and the inner sleeve. The RF connector is configured to be removably coupled between the first board and the second board when axially compressed between the first board and the second board, and a resistance to the axial compression provided by the outer spring and the inner spring holds the RF connector in place with respect to the first board and the second board.

### BRIEF DESCRIPTION OF THE DRAWINGS

FIGS. 1-5 show exemplary embodiments of the systems and methods described herein.

FIG. 1 is a cross-sectional view of an exemplary radio frequency (RF) connector;

FIG. 2 is a partially transparent view of another exemplary RF connector;

FIG. 3 is a perspective view of the exemplary RF connector shown in FIG. 2;

FIG. 4 is a cross-sectional view of another exemplary RF connector; and

FIG. 5 is a flowchart of an exemplary method of manufacturing the RF connector shown in FIG. 1.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, is not to be limited to the precise value specified. In at least some instances, the approximating language may correspond to the precision of an instrument for measuring the value. Here and throughout the specification and claims, range limitations are combined and interchanged, such ranges are identified and include all the sub-ranges contained therein unless context or language indicates otherwise.

The systems and methods described herein facilitate a compressible coaxial board to board interconnect (sometimes referred to herein as a “radio frequency (RF) connector”) that may be used in, for example, a radio frequency (RF) communication system. The RF connector includes multiple spring mechanisms corresponding to conduction paths of the RF connector. The spring mechanisms enable a length of the RF connector to vary when force is applied along an axis of the RF connector. Accordingly, the RF connector can be installed between boards and can function over a range of different distances between the boards. In addition, the RF connector provides a tolerance with respect to an angle that the RF connector is installed with respect to each board (e.g., the axis of the RF connector need not be normal to the boards). Further, the RF connector maintains quality RF performance characteristics, such as a wide operational bandwidth, when installed in varying configurations.

Because the axial compression provided by the spring mechanism holds the RF connector in place with respect to the boards, the RF connector may be removably coupled between the two boards. In other words, the RF connector may remain in place between the two boards without a need for additional coupling mechanisms (e.g., soldering and/or mechanical coupling) between the RF connector and one or both boards. Because of the small size of the RF connector relative to the human hand and the relatively high force needed to separate such coupling mechanisms, is such coupling mechanisms are used, it is generally difficult to separate the boards without damage. Accordingly, because the RF connector requires no such coupling mechanisms, the boards may be readily separated from each other and from the RF connector, increasing ease of accessing the boards during in-field maintenance. Further, in some embodiments, the RF connector is contained within a single-piece housing, increasing ease of manufacture and installation of the RF connector.

The subject matter described herein includes an RF connector including a first outer contactor having a first radially inner surface and defining an axis, an outer sleeve disposed coaxially with the first outer contactor and in contact with the first outer contactor, wherein the first outer contactor is axially translatable with respect to the outer sleeve, and an outer spring in contact with the first outer contactor and configured to resist axial translation of the first outer contactor with respect to the outer sleeve. The RF connector further includes a first inner contactor having a first radially outer surface and disposed coaxially with the first outer contactor, an inner sleeve disposed coaxially with the first outer contactor and in contact with the first inner contactor, wherein the first inner contactor is axially translatable with respect to the inner sleeve, an inner spring in contact with the first inner contactor and configured to resist axial translation of the first inner contactor with respect to the inner sleeve, and a dielectric disposed radially between the outer sleeve and the inner sleeve. The RF connector is configured to be removably coupled between a first board and a second board when axially compressed between the first board and the second board, and a resistance to the axial compression provided by the outer spring and the inner spring holds the RF connector in place with respect to the first board and the second board.

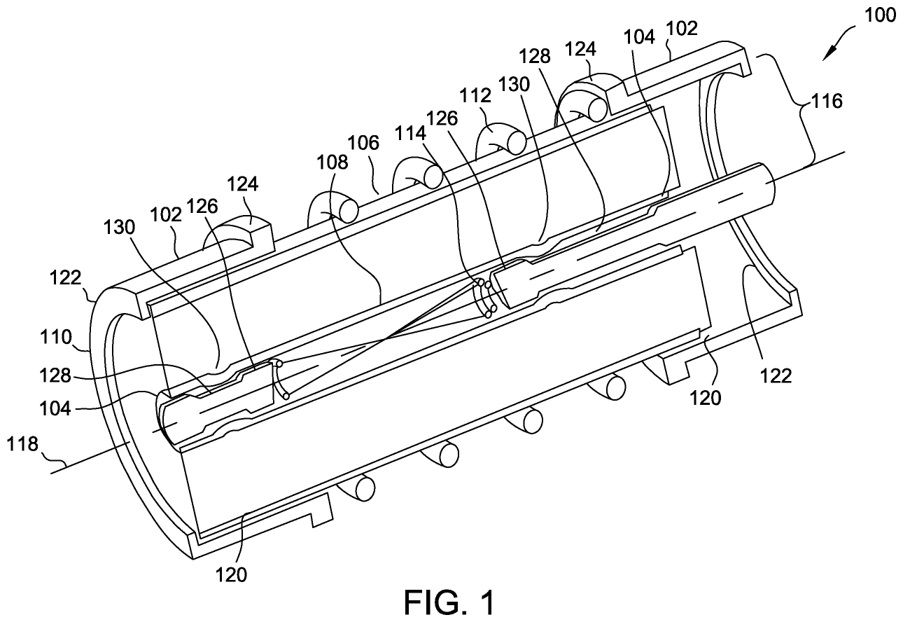

FIG. 1 is a cross-sectional view of an exemplary RF connector 100. RF connector 100 includes a pair of outer contactors 102, a pair of inner contactors 104, an outer sleeve 106, an inner sleeve 108, a dielectric 110, an outer spring 112, and an inner spring 114. In some embodiments, RF connector 100 is coupled between two boards and defines a coaxial transmission line 116 that provides a communicative interconnect between the boards, for example, for RF signals. In such embodiments, outer contactors 102 and inner contactors 104 are electrically coupled between two electronic communication circuits. In some embodiments, the circuits are implemented on, for example, circuit boards, such that signals can be transmitted between the boards via coaxial transmission line 116. In some such embodiments, RF connector 100 is configured to be electrically coupled to the boards without use of mechanical coupling, soldering, or other permanent attachment. Alternatively, in some embodiments, RF connector may be mechanically coupled, soldered, or otherwise attached to the boards. In some such embodiments, outer contactors 102 are electrically coupled to a ground conductor of a respective board, and inner contactors 104 are electrically coupled to signal carrying paths of the boards. RF connector 100 has a longitudinal axis 118 that defines an axial direction.

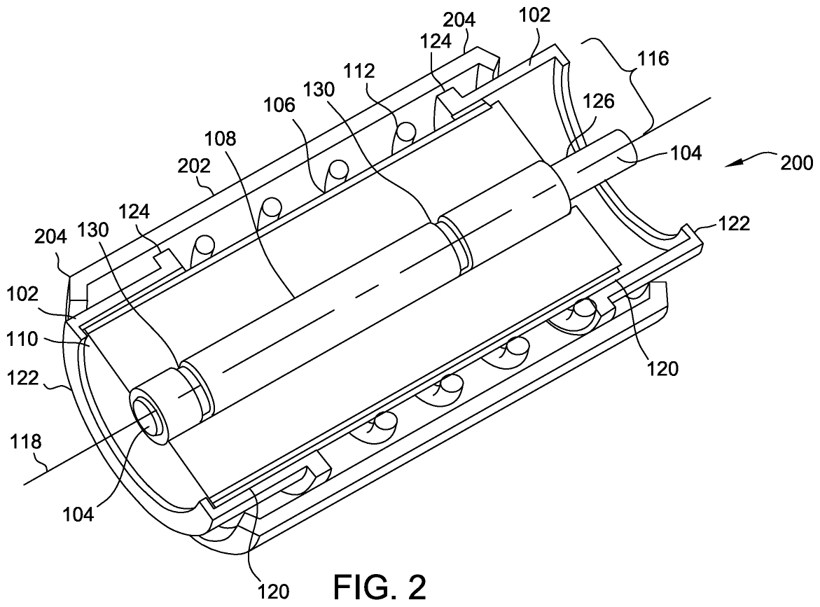

Outer contactors 102, together with outer sleeve 106, form an outer conductor of coaxial transmission line 116. Outer contactors 102 and outer sleeve 106 include a conductive material such as, for example, gold-plated brass. Outer contactors 102 each have a radially inner surface 120 that is in contact with outer sleeve 106. In some embodiments, outer contactors 102 and outer sleeve 106 are substantially annular or tubular in shape, and are disposed coaxially with respect to each other. Outer contactors 102 are freely translatable with respect to outer sleeve 106 in the axial direction with respect to longitudinal axis 118. In some embodiments, outer contactors 102 include one or more inner flanges 122 that restrict a range through which outer contactors 102 can translate axially with respect to outer sleeve 106. In some embodiments, outer contactors 102 further include one or more outer flanges 124 that restrict a range through which outer contactors 102 can translate axially with respect to radially external components such as an external sheath (described in more detail with respect to FIG. 2). In certain embodiments, outer sleeve 106 forms a single-piece housing for RF connector 100, containing at least in part each of the other components of RF connector 100.

Inner contactors 104, together with inner sleeve 108, form an inner conductor of coaxial transmission line 116. Inner contactors 104 and inner sleeve 108 include a conductive material such as, for example, gold-plated brass. Inner contactors 104 have a radially outer surface 126 that is in contact with inner sleeve 108. In some embodiments, inner contactors 104 and inner sleeve 108 are substantially annular or tubular in shape, and inner contactors 104 and inner sleeve 108 are disposed coaxially with respect to each other and with respect to outer contactors 102 and outer sleeve 106. Dielectric 110 is disposed radially between outer sleeve 106 and inner sleeve 108, and includes an insulating material such as, for example, Teflon. Inner contactors 104 are freely translatable with respect to inner sleeve 108 in the axial direction. In some embodiments, inner contactors 104 include one or more indented portions 128 that are configured to receive respective raised portions 130 of inner sleeve 108. As such, indented portions 128 and raised portions 130 limit a range through which inner contactors 104 can translate axially with respect to inner sleeve 108. In such embodiments, indented portions 128 and raised portions 130 may include, for example, a single ring or a series of small protrusions and indents disposed radially about inner contactor 104.

In some embodiments, outer spring 112 is positioned between outer contactors 102 and radially outward with respect to outer sleeve 106, and is configured to provide resistance to axial translation of outer contactors 102 with respect to each other and with respect to outer sleeve 106. Similarly, inner spring 114 is positioned between inner contactors 104 and radially inward with respect to inner sleeve 108, and is configured to provide resistance to axial translation of inner contactors 104 with respect to each other and with respect to inner sleeve 108. As such, when an axial compressing force is applied to RF connector 100, outer contactors 102 and/or inner contactors 104 can move axially toward each other such that a length of RF connector is variable. Accordingly, a single RF connector 100 can tolerate a range of different installation configurations such as, for example, different distances between boards. Additionally, RF connector 100 provides a tolerance with respect to an angle that the RF connector 100 is installed with respect to each board. For example, RF connector 100 need not be installed at a normal angle with respect to the boards.

RF connector 100 is configured to be removably coupled between a first board and a second board, and a resistance to compression about longitudinal axis 118 provided by outer spring 112 and the inner spring 114 holds RF connector 100 in place with respect to the first board and the second board. Accordingly, no soldering, mechanical coupling, or other attachment mechanisms are necessary to hold RF connector 100 in place with respect to the boards.

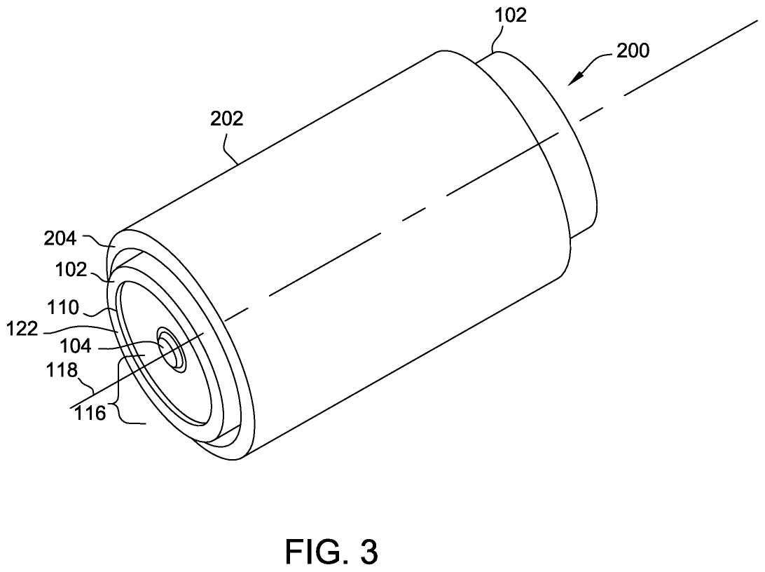

FIG. 2 is a partially transparent view of another exemplary RF connector 200. In FIG. 2, inner contactors 104 and inner sleeve 108 are shown in their entirety, and other components are shown in cross-section for clarity. FIG. 3 is a perspective view of RF connector 200. RF connector 200 includes outer contactors 102, inner contactors 104, outer sleeve 106, inner sleeve 108, dielectric 110, outer spring 112, and inner spring 114, which generally function as described with respect to FIG. 1. RF connector 200 further includes an external sheath 202 disposed radially outward from outer contactors 102 and outer spring 112. External sheath 202 protects and holds intact interior components of RF connector 200. In some embodiments, external sheath 202 includes one or more end flanges 204 extending radially inward. End flanges 204, together with outer flanges 124 of outer contactors 102, limit the range through which outer contactors 102 can axially translate with respect to external sheath 202.

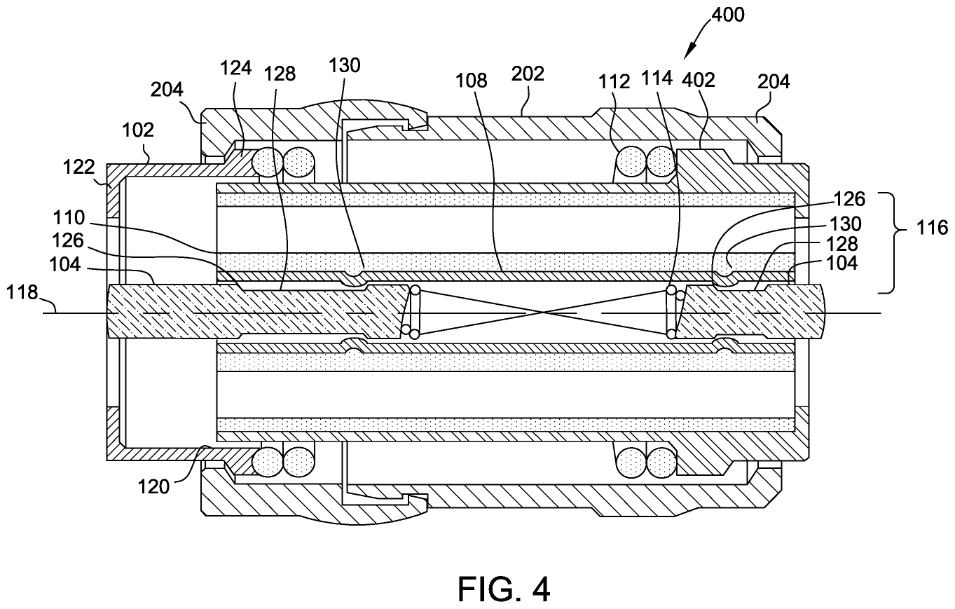

FIG. 4 is a cross-sectional view of another exemplary RF connector 400. RF connector 400 includes outer contactor 102, inner contactors 104, outer sleeve 106, inner sleeve 108, dielectric 110, outer spring 112, and inner spring 114, which generally function as described with respect to FIG. 1. In this embodiment, RF connector 400 includes a single outer contactor 102. Further, as illustrated in FIG. 4, outer spring 112 is disposed between outer contactor 102 and a ledge 402 of outer sleeve 106, such that outer spring 112 resists axial translation of outer contactor 102 with respect to outer sleeve 106. Similar to the additional outer contactor 102 in other embodiments (e.g., RF connector 100 and 200), outer sleeve 106 is configured to be electrically coupled directly to a conductor of an external board in combination with a respective inner contactor 104.

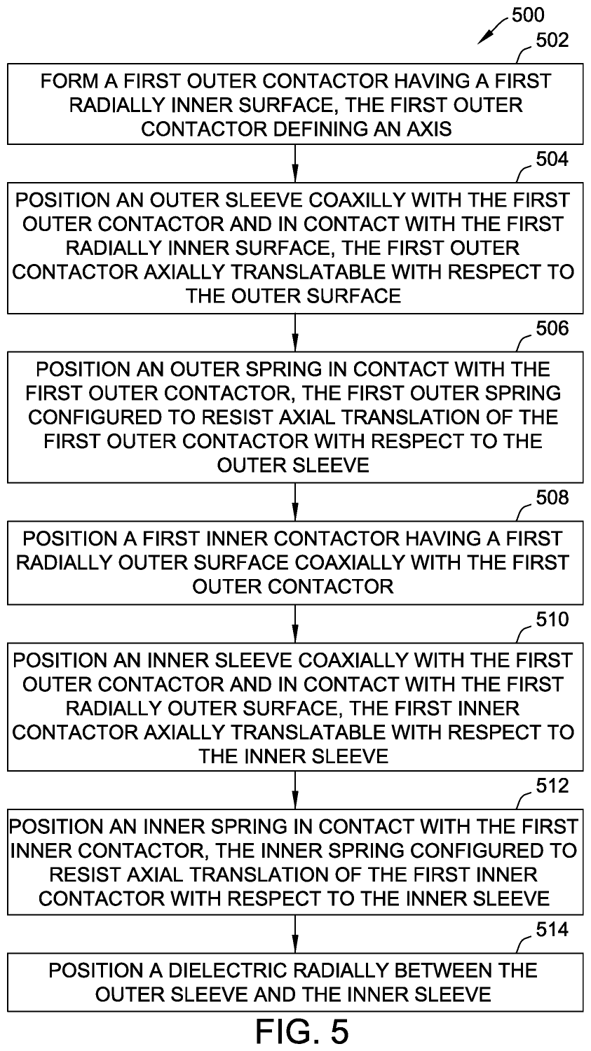

FIG. 5 is a flowchart of an exemplary method 500 of manufacturing RF connector 100 (shown in FIG. 1). Method 500 includes forming 502 a first outer contactor (such as outer contactor 102) having a first radially inner surface (such as radially inner surface 120). The first outer contactor defines an axis. In some embodiments, the first outer contactor is substantially tubular in shape.

Method 500 further includes positioning 504 an outer sleeve (such as outer sleeve 106) coaxially with the first outer contactor and in contact with the first outer contactor. The first outer contactor is axially translatable with respect to the outer sleeve. In some embodiments, the outer sleeve is substantially tubular in shape. In some embodiments, the outer sleeve forms a single-piece housing for the RF connector.

Method 500 further includes positioning 506 an outer spring (such as outer spring 112) in contact with the first outer contactor. The first outer spring is configured to resist axial translation of the first outer contactor with respect to the outer sleeve.

Method 500 further includes positioning 508 a first inner contactor (such as inner contactor 104) having a first radially outer surface (such as radially outer surface 126) coaxially with the first outer contactor. In some embodiments, the first inner contactor is substantially cylindrical in shape.

Method 500 further includes positioning 510 an inner sleeve (such as inner sleeve 108) coaxially with the first outer contactor and in contact with the first inner contactor. The first inner contactor is axially translatable with respect to the inner sleeve. In some embodiments, the inner sleeve is substantially tubular in shape.

Method 500 further includes positioning 512 an inner spring (such as inner spring 114) in contact with the first inner contactor. The inner spring is configured to resist axial translation of the first inner contactor with respect to the inner sleeve.

Method 500 further includes positioning 514 a dielectric (such as dielectric 110) radially between the outer sleeve and the inner sleeve. The RF connector is configured to be removably coupled between a first board and a second board when axially compressed between the first board and the second board, and a resistance to the axial compression provided by the outer spring and the inner spring holds the RF connector in place with respect to the first board and the second board.

In some embodiments, method 500 further includes positioning a second inner contactor having a second radially outer surface coaxially with the first outer contactor. The inner sleeve is further in contact with and axially translatable with respect to the second inner contactor. In such embodiments, method 500 further includes positioning the inner spring is in contact with the second inner contactor, the inner spring further configured to resist axial translation of the second inner contactor with respect to the inner sleeve.

In some embodiments, method 500 further includes positioning a second outer contactor having a second radially inner surface coaxially with the first outer contactor. The outer sleeve is further in contact with and axially translatable with respect to the second outer contactor. In such embodiments, method 500 further includes positioning the outer spring in contact with the second outer contactor, the outer spring further configured to resist axial translation of the second outer contactor with respect to the outer sleeve.

In some embodiments, method 500 further includes forming, on the outer contactor, an inner flange (such as inner flange 122) extending radially inward and configured to limit axial motion of the first outer contactor with respect to the outer sleeve.

In some embodiments, method 500 further includes positioning an external sheath (such as external sheath 202) radially outward from the first outer contactor and the outer sleeve. In some such embodiments, method 500 further includes forming, on the outer contactor, an outer flange extending radially outward and configured to limit axial motion of the first outer contactor with respect to the external sheath. In some such embodiments, method 500 further includes forming, on the external sheath, an end flange extending radially inward and configured to limit axial motion of the first outer contactor with respect to the external sheath.

In some embodiments, method 500 further includes forming, on the outer sleeve, a ledge (such as ledge 402) extending radially outward. In some such embodiments, the outer spring is configured to be in contact with the ledge of the outer sleeve.

Exemplary embodiments of methods and systems for board to board RF connections are described above in detail. The methods and systems are not limited to the specific embodiments described herein, but rather, components of systems and/or steps of the methods may be used independently and separately from other components and/or steps described herein. Accordingly, the exemplary embodiment can be implemented and used in connection with many other applications not specifically described herein.

Technical effects of the systems and methods described herein include at least one of: (a) an ability for a board to board RF connector to tolerate a range of distances between boards by using an inner spring and an outer spring that enable a length of the RF connector to be varied; (b) an ability to form RF connections between boards with a single RF connector by providing an RF connector having a variable length; (c) improving a RF signal carrying quality of RF connectors by using a single piece RF connector having a variable length to form an RF connection between boards; (d) reducing the space of an RF connection between boards by using a variable length RF connector; and (e) reducing the material used to form an RF connection between boards by using a variable length RF connector.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose various embodiments, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A radio frequency (RF) connector comprising:
a first outer contactor comprising a first radially inner surface and defining an axis;
an outer sleeve coaxial with said first outer contactor and in contact with said first outer contactor, wherein said first outer contactor is axially translatable with respect to said outer sleeve;
an outer spring in contact with said first outer contactor and configured to resist axial translation of said first outer contactor with respect to said outer sleeve;
a first inner contactor comprising a first radially outer surface and coaxial with said first outer contactor;
an inner sleeve coaxial with said first outer contactor and in contact with said first inner contactor, wherein said first inner contactor is axially translatable with respect to said inner sleeve;
an inner spring in contact with said first inner contactor and configured to resist axial translation of said first inner contactor with respect to said inner sleeve; and
a dielectric disposed radially between said outer sleeve and said inner sleeve, wherein said RF connector is configured to be removably coupled between a first board and a second board when axially compressed between the first board and the second board, and wherein a resistance to the axial compression provided by said outer spring and said inner spring holds said RF connector in place with respect to the first board and the second board.

2. The RF connector of claim 1, further comprising a second inner contactor comprising a second radially outer surface and coaxial with said first outer contactor, wherein said inner sleeve is further in contact with and axially translatable with respect to said second inner contactor, and wherein said inner spring is further in contact with said second inner contactor and further configured to resist axial translation of said second inner contactor with respect to said inner sleeve.

3. The RF connector of claim 1, further comprising a second outer contactor comprising a second radially inner surface and coaxial with said first outer contactor, wherein said outer sleeve is further in contact with and axially translatable with respect to said second outer contactor, and wherein said outer spring is further in contact with said second outer contactor and further configured to resist axial translation of said second outer contactor with respect to said outer sleeve.

4. The RF connector of claim 1, wherein said first outer contactor comprises an inner flange extending radially inward and configured to limit axial translation of said first outer contactor with respect to said outer sleeve.

5. The RF connector of claim 1, wherein said inner sleeve comprises a raised portion, and wherein said first radially outer surface of first inner contactor defines an indented portion configured to receive said raised portion to limit axial translation of said first inner contactor with respect to said inner sleeve.

6. The RF connector of claim 1, further comprising an external sheath disposed radially outward from said first outer contactor and said outer sleeve.

7. The RF connector of claim 6, wherein said first outer contactor comprises an outer flange extending radially outward and configured to limit axial translation of said first outer contactor with respect to said external sheath.

8. The RF connector of claim 6, wherein said external sheath comprises an end flange extending radially inward and configured to limit axial translation of said first outer contactor with respect to said external sheath.

9. The RF connector of claim 1, wherein said outer sleeve comprises a ledge extending radially outward.

10. The RF connector of claim 9, wherein said outer spring is in contact with said ledge of said outer sleeve.

11. The RF connector of claim 1, wherein said first outer contactor is substantially tubular in shape.

12. The RF connector of claim 1, wherein said first inner contactor is substantially cylindrical in shape.

13. The RF connector of claim 1, wherein at least one of said first outer contactor and said first inner contactor comprises gold-plated brass.

14. The RF connector of claim 1, wherein said dielectric comprises Teflon.

15. The RF connector of claim 1, wherein said outer sleeve forms a single-piece housing for said RF connector.

16. A method of manufacturing a radio frequency (RF) connector, said method comprising:
forming a first outer contactor having a first radially inner surface, the first outer contactor defining an axis;
positioning an outer sleeve coaxially with the first outer contactor and in contact with the first outer contactor, the first outer contactor axially translatable with respect to the outer sleeve;
positioning an outer spring in contact with the first outer contactor, the outer spring configured to resist axial translation of the first outer contactor with respect to the outer sleeve;
positioning a first inner contactor coaxially with the first outer contactor, the first inner contactor including a first radially outer surface;
positioning an inner sleeve coaxially with the first outer contactor and in contact with the first inner contactor, the first inner contactor axially translatable with respect to the inner sleeve;
positioning an inner spring in contact with the first inner contactor, the inner spring configured to resist axial translation of the first inner contactor with respect to the inner sleeve; and
positioning a dielectric radially between the outer sleeve and the inner sleeve, wherein the RF connector is configured to be removably coupled between a first board and a second board when axially compressed between the first board and the second board, and wherein a resistance to the axial compression provided by the outer spring and the inner spring holds the RF connector in place with respect to the first board and the second board.

17. The method of claim 16, further comprising:
positioning a second inner contactor coaxially with the first outer contactor, the second inner contactor having a second radially outer surface, wherein the inner sleeve is further in contact with and axially translatable with respect to the second inner contactor; and
positioning the inner spring is in contact with the second inner contactor, the inner spring further configured to resist axial translation of the second inner contactor with respect to the inner sleeve.

18. The method of claim 16, further comprising:
positioning a second outer contactor coaxially with the first outer contactor, the second outer contactor having a second radially inner, wherein the outer sleeve is further in contact with and axially translatable with respect to the second outer contactor; and
positioning the outer spring in contact with the second outer contactor, the outer spring further configured to resist axial translation of the second outer contactor with respect to the outer sleeve.

19. The method of claim 16, further comprising forming, on the first outer contactor, an inner flange extending radially inward and configured to limit axial translation of the first outer contactor with respect to the outer sleeve.

20. A radio frequency (RF) assembly comprising:
a first board;
a second board; and
an RF connector comprising:
a first outer contactor comprising a first radially inner surface and defining an axis;
an outer sleeve coaxial with said first outer contactor and in contact with said first outer contactor, wherein said first outer contactor is axially translatable with respect to said outer sleeve;
an outer spring in contact with said first outer contactor and configured to resist axial translation of said first outer contactor with respect to said outer sleeve;
a first inner contactor comprising a first radially outer surface and coaxial with said first outer contactor;
an inner sleeve coaxial with said first outer contactor and in contact with said first inner contactor, wherein said first inner contactor is axially translatable with respect to said inner sleeve;
an inner spring in contact with said first inner contactor and configured to resist axial translation of said first inner contactor with respect to said inner sleeve; and
a dielectric disposed radially between said outer sleeve and said inner sleeve, wherein said RF connector is configured to be removably coupled between said first board and said second board when axially compressed between said first board and said second board, and wherein a resistance to the axial compression provided by said outer spring and said inner spring holds said RF connector in place with respect to said first board and said second board.
